(19) United States
(12) Patent Application Publication
(10) Pub. No.: US 2026/0085974 A1
(43) Pub. Date: Mar. 26, 2026

(54) METHOD FOR MEASURING LUMINESCENCE DISTRIBUTION

(71) Applicant: EVERFINE DISPLAY MEASUREMENT TECHNOLOGY CO., LTD., Hangzhou (CN)

(72) Inventors: Jiangen PAN, Hangzhou (CN); Yan LI, Hangzhou (CN); Qian LI, Hangzhou (CN)

(73) Assignee: EVERFINE DISPLAY MEASUREMENT TECHNOLOGY CO., LTD., Hangzhou (CN)

(21) Appl. No.: 19/311,092

(22) Filed: Aug. 27, 2025

(30) Foreign Application Priority Data
Sep. 23, 2024 (CN) 202411320201.X

(51) Int. Cl. G01J 1/44; G01J 1/42

(52) U.S. Cl. CPC G01J 1/44; G01J 2001/4247

(57) ABSTRACT

A method for measuring a luminous distribution is as follows: the spatial luminous distribution of a light source is measured through a curved mesh screen and an imaging measurement unit which comprises an area array sensor, specifically comprising: the curved mesh screen has a sampling port, and the surface of the curved mesh screen has diffuse transmission elements distributed in a grid pattern; a to-be-measured region of the light source is placed at the sampling port, light emitted from the to-be-measured region irradiates the curved mesh screen to form a light spot on each diffuse transmission element, and each light spot region corresponds to a spatial angle; the imaging measurement unit obtains a light image formed by the diffuse transmission elements on the curved mesh screen; and a data processing unit analyzes the light image to obtain angular resolved optical quantities of the to-be-measured region.

### TECHNICAL FIELD

The present invention relates to the field of photoelectric testing, and specifically to a method for measuring a luminous distribution.

### BACKGROUND

For display or indication light sources, such as LED (Light Emitting Diode), OLED (Organic Light Emitting Diode), Mini-LED, and Micro-LED, their viewing angle characteristics, namely, their luminance and chromaticity at different spatial angles, are important optical properties. For illumination light sources, their luminous intensity distribution in different spaces is mainly studied. Light distribution information is precisely detected during research & development and production to ensure product quality. Conventional spatial luminous distribution test adopts a photometer for scanning and measurement within the entire space. Although the test precision is relatively high, the adopted mechanical rotating structure requires point-by-point measurement, resulting in long test time and low efficiency. In addition, a certain distance between a detector and a light source usually requires the scanning test to be carried out in a relatively large dark room, which significantly increases costs. Another spatial light distribution characteristic test adopts a dedicated optical system that combines a Fourier optical lens and a CMOS (Complementary Metal Oxide Semiconductor) sensor to simultaneously measure viewing angle characteristics within a maximum ±80° angle. The entire test process does not involve any moving component and takes only a few seconds to tens of seconds. However, due to the extremely precise and complex structure of the optical lens, its implementation cost is quite high.

### SUMMARY

In view of the shortcomings of the prior art, the present invention provides a method for measuring a luminous distribution, aiming to solve the problems of long test time, high equipment cost, etc. in existing technical solutions. The measuring method provided by the present invention can quickly measure the viewing angle characteristics of a light source, ensuring the consistency and accuracy of measurement results and greatly reducing equipment costs.

To achieve the above objective, technical solutions adopted by the present invention are as follows:

The present invention provides a method for measuring a luminous distribution, where the spatial luminous distribution of a light source is measured through a curved mesh screen and an imaging measurement unit which comprises an area array sensor, a sampling port is involved, and the surface of the curved mesh screen has diffuse transmission elements distributed in a grid pattern; measuring steps include: placing a to-be-measured region of the light source at the sampling port, where light emitted from the to-be-measured region illuminates the curved mesh screen to form a light spot on each diffuse transmission element, and each light spot region corresponds to a spatial angle; obtaining a light image formed by the diffuse transmission elements on the curved mesh screen with the imaging measurement unit; and analyzing the light image by a data processing unit to obtain angular resolved optical quantities of the to-be-measured region.

The optical quantities include, but are not limited to, angle-related parameters such as luminous intensity, luminance, chromaticity, radiance, and radiant intensity. The diffuse transmission elements covering the surface of the curved mesh screen in the grid pattern can scatter incident light uniformly to form measurable light spots, where each light spot region corresponds to a specific spatial angle. The imaging measurement unit is equipped with a high-resolution area array sensor to capture the light image formed by the diffuse transmission elements on the curved mesh screen and record information such as luminance and color of the light spots. To ensure the accuracy of test results, it is necessary to eliminate the interference of stray light such as ambient light or internal reflected light. A shielding device is provided between the curved mesh screen and the light source as well as between the curved mesh screen and the imaging measurement unit, or they are coated with black light-absorbing materials. In this technical solution, the sampling port is arranged on the central vertical axis of the curved mesh screen or at an appropriate position, and the light source is placed at the sampling port to ensure that the emitted light can be projected onto the curved mesh screen without obstruction, as shown in FIG. 1. The angular resolution of the measurement can be improved by increasing the density of diffuse transmission elements on the curved mesh screen or optimizing lens parameters of the imaging measurement unit. To further improve measurement efficiency and ease of use, the measuring system can be integrated as an automated device, which can implement automatic positioning of the light source, automatic calibration of the imaging measurement unit, and automatic processing and analysis of measurement data by writing control software.

As a technical solution, a relationship between each pixel or pixel region of the area array sensor in the imaging measurement unit and a spatial light-emitting angle from the to-be-measured region is established based on the spatial position relationship between different diffuse transmission elements on the curved mesh screen and the sampling port, and the position relationship between the diffuse transmission elements and the imaging measurement unit. The sampling port and the diffuse transmission elements on the surface of the curved mesh screen are usually small, indicating that each diffuse transmission element receives parallel rays of only a specific angle from the light source, that is, light rays entering the diffuse transmission element are parallel light, so that the image obtained by the imaging measurement unit contains viewing angle information. The overall measurement relationship between the light source and the curved mesh screen is shown in FIG. 2.

In order to determine the relationship between different diffuse transmission elements of the curved mesh screen and pixels in the area array sensor, a geometric relationship is established, mainly including four coordinate systems: (1) a pixel coordinate system, which is a rectangular coordinate system established on an image plane in the imaging measurement unit, as shown in FIG. 3, with the first pixel Oₚ at the upper left corner as its origin, i axis and j axis parallel to two edges of the area array sensor, reflecting the arrangement of each pixel in the area array sensor of the imaging measurement unit; (2) an image coordinate system, with an origin O_{I} located at the center of the image plane, namely, the center of the area array sensor, x axis parallel to the i axis of the pixel coordinate system, and y axis parallel to the j axis, for describing the physical dimensions and coordinates of the image, where the coordinate values are expressed in units of the actual physical dimensions; (3) an imaging measurement unit coordinate system, with the lens center O_{L} of the imaging measurement unit as its origin, X_{L} axis and y_{L} axis parallel to the x axis and y axis of the image coordinate system, and z_{L} axis perpendicular to the image coordinate system along the optical axis of the imaging measurement lens, where the intersection of the z_{L} axis and the image coordinate system is the origin O_{I} of the image coordinate system; and (4) a spatial light distribution coordinate system, described by O_{S} point, X_{S} axis, Y_{S} axis and Z_{S} axis, usually with the center O_{S} of the sampling port as its origin. Specific transformation processes among the several coordinate systems are as follows:

Firstly, the pixel coordinate system is established in units of pixels. The representation of pixels cannot reflect the physical dimensions of an object in the image, and the positions of pixels need to be represented by physical units. Therefore, the image coordinate system in millimeters (mm) or micrometers (m) is established. The origin Oₚ of the pixel coordinate system is translated to the center O_{I} of the image plane, as shown in FIG. 3. The coordinates of the center O_{I} of the image plane in the pixel coordinate system are denoted as (i₀, j₀), the physical dimension of each pixel in the area array sensor is dx×dy, the relationship between the coordinates (x, y) in the image coordinate system and the coordinates (i, j) in the pixel coordinate systemis:

$$\{ \begin{matrix}x = idx - {i}_{0} dx \\ y = jdy - {j}_{0} dy\end{matrix} ,$$

expressed in a matrix form as:

$$[ \begin{matrix}x \\ y\end{matrix} ] = [ \begin{matrix}dx & 0 \\ 0 & dy\end{matrix} ] [ \begin{matrix}i \\ j\end{matrix} ] + [ \begin{matrix}- {i}_{0} dx \\ - {j}_{0} dy\end{matrix} ] ,$$

and transformed into a homogeneous coordinate form as:

$$[ \begin{matrix}x \\ y \\ 1\end{matrix} ] = [ \begin{matrix}dx & 0 & 0 \\ 0 & dy & 0 \\ 0 & 0 & 0\end{matrix} ] [ \begin{matrix}i \\ j \\ 0\end{matrix} ] + [ \begin{matrix}- {i}_{0} dx \\ - {j}_{0} dy \\ 1\end{matrix} ] = [ \begin{matrix}dx & 0 & - {i}_{0} dx \\ 0 & dy & - {j}_{0} dy \\ 0 & 0 & 0\end{matrix} ] [ \begin{matrix}i \\ j \\ 1\end{matrix} ] ,$$

$$namely , [ \begin{matrix}i \\ j \\ 1\end{matrix} ] = [ \begin{matrix}\frac{1}{dx} & 0 & {i}_{0} \\ 0 & \frac{1}{dy} & {j}_{0} \\ 0 & 0 & 1\end{matrix} ] [ \begin{matrix}x \\ y \\ 1\end{matrix} ] .$$

The distance between the origin O_{L} of the imaging measurement unit coordinate system and the origin O_{I} of the image coordinate system is f, where f represents a focal length of a lens. When the diffuse transmission element is imaged onto the image coordinate system, as shown in FIG. 4, point A_{L} (x_{L}, y_{L}, Z_{L}) represents coordinates of the diffuse transmission element in the imaging measurement unit coordinate system, and point E_{I}(x,y) represents coordinates of point A_{L} imaged in the image coordinate system; point C_{L}(x_{L},0,Z_{L}) represents a projection of point A_{L} on the x_{L}O_{L}Z_{L} plane, point B_{L}(0,0,Z_{L}) represents a projection of point C_{L} on the Z_{L} axis of the imaging measurement unit coordinate system, and point D_{I}(x,0) represents a projection of point E_{I} on the x axis of the image coordinate system. According to the similarity theorem of triangles,

$$\frac{{O}_{L} {O}_{I}}{{O}_{L} {B}_{L}} = \frac{{O}_{I} {D}_{I}}{{B}_{L} {C}_{L}} = \frac{{E}_{I} {D}_{I}}{{A}_{L} {C}_{L}} = \frac{{O}_{L} {D}_{I}}{{O}_{L} {C}_{L}} = \frac{f}{{z}_{L}} = \frac{x}{{x}_{L}} = \frac{y}{{y}_{L}} ,$$

$$[ \begin{matrix}{x}_{L} \\ {y}_{L} \\ {z}_{L} \\ 1\end{matrix} ] = [ \begin{matrix}\frac{{z}_{L}}{f} & 0 & 0 \\ 0 & \frac{{z}_{L}}{f} & 0 \\ 0 & 0 & {z}_{L} \\ 0 & 0 & 1\end{matrix} ] [ \begin{matrix}x \\ y \\ 1\end{matrix} ]$$

is then obtained.

The spatial light distribution coordinate system is established with the center O_{S} of the sampling port as its origin, parallel to the imaging measurement unit coordinate system. When the lens center of the imaging measurement unit is located in the normal direction of the center of the sampling port, that is, the line connecting the lens center of the imaging measurement unit and the center of the sampling port is the Z_{L} axis, the imaging measurement unit coordinate system is translated along the Z_{L} axis to obtain the spatial light distribution coordinate system. The diffuse transmission element is denoted as A_{S}(X_{S}, Y_{S}, Z_{S}) in the spatial light distribution coordinate system and A_{L} (x_{L}, y_{L}, Z_{L}) in the imaging measurement unit coordinate system, then A_{S}(X_{S}, Y_{S}, Z_{S}) can be expressed in the imaging measurement unit coordinate system as:

$$\{ \begin{matrix}{X}_{S} = {x}_{L} + {t}_{x} \\ {Y}_{S} = {y}_{L} + {t}_{y} \\ {Z}_{S} = {z}_{L} + {t}_{z}\end{matrix} ,$$

where tₓ and t_{y} are 0. The relationship between the imaging measurement unit coordinate system and the spatial light distribution coordinate system can be expressed as:

$$[ \begin{matrix}{X}_{S} \\ {Y}_{S} \\ {Z}_{S} \\ 1\end{matrix} ] = [ \begin{matrix}R & T \\ 0 & 1\end{matrix} ] [ \begin{matrix}{x}_{L} \\ {y}_{L} \\ {z}_{L}\end{matrix} ] ,$$

where R=RₓR_{y}R_{z} represents a three-row and three-column rotation transformation matrix of the imaging measurement unit coordinate system relative to the spatial light distribution coordinate system Since the imaging measurement unit coordinate system and the spatial light distribution coordinate system are in a parallel relationship (without rotation), the rotation matrix is a 3×3 identity matrix

$$[ \begin{matrix}1 & 0 & 0 \\ 0 & 1 & 0 \\ 0 & 0 & 1\end{matrix} ] , and T = [ \begin{matrix}{t}_{x} \\ {t}_{y} \\ {t}_{z}\end{matrix} ]$$

represents a three-row and one-column translation matrix. When the lens center of the imaging measurement unit deviates from the normal direction of the center of the sampling port, corresponding transformation can be carried out through the rotation matrix (3×3 identity matrix). The transformation relationship between the pixel coordinates of the area array sensor in the pixel coordinate system and the point coordinates of the diffuse transmission element in the spatial light distribution coordinate system can be expressed as:

$$[ \begin{matrix}{X}_{S} \\ {Y}_{S} \\ {Z}_{S} \\ 1\end{matrix} ] = [ \begin{matrix}R & T \\ 0 & 1\end{matrix} ] [ \begin{matrix}\frac{{z}_{L}}{f} & 0 & 0 \\ 0 & \frac{{z}_{L}}{f} & 0 \\ 0 & 0 & {z}_{L} \\ 0 & 0 & 1\end{matrix} ] [ \begin{matrix}dx & 0 & - {i}_{0} dx \\ 0 & dy & - {j}_{0} dy \\ 0 & 0 & 1\end{matrix} ] [ \begin{matrix}i \\ j \\ 1\end{matrix} ] = [ \begin{matrix}R & T \\ 0 & 1\end{matrix} ] [ \begin{matrix}\frac{{z}_{L} dx}{f} & 0 & \frac{- {z}_{L} {i}_{0} dx}{f} \\ 0 & \frac{{z}_{L} d y}{f} & \frac{- {z}_{L} {j}_{0} d y}{f} \\ 0 & 0 & {z}_{L} \\ 0 & 0 & 1\end{matrix} ] [ \begin{matrix}i \\ j \\ 1\end{matrix} ]$$

The above describes the transformation process from the pixel coordinates of the area array sensor in the pixel coordinate system to the point coordinates of the diffuse transmission element in the spatial light distribution coordinate system. Similarly, the transformation relationship from the point coordinates of the diffuse transmission element in the spatial light distribution coordinate system to the pixel coordinates of the area array sensor in the pixel coordinate system can be expressed as:

$${z}_{L} [ \begin{matrix}i \\ j \\ 1\end{matrix} ] = {[ \begin{matrix}dx & 0 & {i}_{0} \\ 0 & dy & {j}_{0} \\ 0 & 0 & 1\end{matrix} ] [ \begin{matrix}f & 0 & 0 & 0 \\ 0 & f & 0 & 0 \\ 0 & 0 & 1 & 0\end{matrix} ] [ \begin{matrix}R & T \\ 0 & 1\end{matrix} ]}^{- 1} [ \begin{matrix}{X}_{S} \\ {Y}_{S} \\ {Z}_{S} \\ 1\end{matrix} ] = [ \begin{matrix}\frac{f}{dx} & 0 & {i}_{0} \\ 0 & \frac{f}{dy} & {j}_{0} \\ 0 & 0 & 1\end{matrix} ] {[ \begin{matrix}R & T \\ 0 & 1\end{matrix} ]}^{- 1} [ \begin{matrix}{X}_{S} \\ {Y}_{S} \\ {Z}_{S} \\ 1\end{matrix} ] .$$

The known point coordinates of each diffuse transmission element in the spatial light distribution coordinate system are (X_{S},Y_{S},Z_{S}), which are transformed into polar coordinates (l, θ, φ) expressed as:

$$l = \sqrt{{X}_{S}^{2} + {Y}_{S}^{2} + {Z}_{S}^{2}} , θ = arcsin ( \frac{{Z}_{S}}{l} ) , φ = arctan ( \frac{{Y}_{S}}{{X}_{S}} ) .$$

Each pixel (i, j) or each pixel region centered on the pixel (i,j) in the imaging measurement unit corresponds to the position (X_{S}, Y_{S}, Z_{S}) of the diffuse transmission element, thereby establishing a relationship between each pixel (i, j) or each pixel region centered on the pixel (i, j) in the imaging measurement unit and a spatial light-emitting angle (θ, φ) from the to-be-measured region, which is of great significance for subsequent data calculation, processing, and analysis.

Relevant symbol explanations and coordinate system transformation relationships are shown in Tables 1 and 2.

TABLE 1
Symbol explanations

| Symbol | Description |
|---|---|
| O_{P} - ij | A pixel coordinate system with the first pixel at the edge of the area |
| | array sensor as the origin |
| O_{I} - xy | An image coordinate system with the center of the area array sensor |
| | as the origin |
| O_{L} - x_{L}y_{L}z_{L} | An imaging measurement unit coordinate system with the lens center |
| | of the imaging measurement unit as the origin |
| O_{S} - X_{S}Y_{S}Z_{S} | A spatial light distribution coordinate system with the center of the |
| | sampling port as the origin |
| dx, dy | Physical dimensions of each pixel of the area array sensor |
| (i₀, j₀) | Pixel coordinates of the center of the image plane |
| A_{L}(x_{L}, y_{L}, z_{L}) | Coordinates of the diffuse transmission element in the imaging |
| | measurement unit coordinate system |
| A_{S}(X_{S}, Y_{S}, Z_{S}) | Coordinates of the diffuse transmission element in the spatial light |
| | distribution coordinate system |
| E_{I}(x, y) | Coordinates of point A_{L}(x_{L}, y_{L}, z_{L}) imaged in the image coordinate |
| | system |
| C_{L}(x_{L}, 0, z_{L}) | Projection of point A_{L}(x_{L}, y_{L}, z_{L}) on the x_{L}O_{L}z_{L} plane |
| B_{L}(0, 0, z_{L}) | Projection of point C_{L} on the z_{L} axis |
| D_{I}(x, 0) | Projection of point E_{I} on the x axis in the image coordinate system |
| R | Three-row and three-column rotation transformation matrix of the |
| | imaging measurement unit coordinate system relative to the spatial |
| | light distribution coordinate system |
| T | Three-row and one-column translation matrix |
| f | Focal length of the lens in the imaging measurement unit |
| (θ, φ) | Position coordinates of the diffuse transmission element on the curved |
| | mesh screen in the polar coordinate system |
| L(θ, φ) | Luminance of the to-be-measured region at the spatial angle |
| k(i, j) | Calibration coefficient k(i, j) for each pixel (i, j) in the imaging |
| | measurement unit |
| R(i, j) | Response value of each pixel (i, j) in the imaging measurement unit |
| I(i, j) | Luminous intensity of the light source in the specified direction |
| Eₚᵢₓₑₗ(i, j) | Illuminance value of each measured pixel (i, j) or pixel region |
| | centered on each pixel (i, j) |
| l | Distance between the surface of the light source and each diffuse |
| | transmission element of the curved mesh screen |
| α(i, j) | Angle formed by the normal direction of each diffuse transmission |
| | element and the l direction |
| β(i, j) | Angle formed by the plane normal of the area detector in the imaging |
| | measurement unit and the line connecting the diffuse transmission |
| | element and the image plane (i, j) |
| τ_{screen} | Transmittance of the diffuse transmission element |
| τₗₑₙₛ | Transmittance of the lens in the imaging measurement unit |

TABLE 2
Coordinate system transformation relationships

| Coordinate system | Transformation relationship |
|---|---|
| Image coordinate system - pixel coordinate system | $[ \begin{matrix}i \\ j \\ 1\end{matrix} ] = [ \begin{matrix}\frac{1}{dx} & 0 & {i}_{0} \\ 0 & \frac{1}{dy} & {j}_{0} \\ 0 & 0 & 1\end{matrix} ] [ \begin{matrix}x \\ y \\ 1\end{matrix} ]$ |
| Image coordinate system - imaging measurement unit coordinate system | $[ \begin{matrix}{x}_{L} \\ {y}_{L} \\ {z}_{L} \\ 1\end{matrix} ] = [ \begin{matrix}\frac{{z}_{L}}{f} & 0 & 0 \\ 0 & \frac{{z}_{L}}{f} & 0 \\ 0 & 0 & {z}_{L} \\ 0 & 0 & 1\end{matrix} ] [ \begin{matrix}x \\ y \\ 1\end{matrix} ]$ |
| Imaging measurement unit coordinate system - spatial light distribution coordinate system | $[ \begin{matrix}{X}_{S} \\ {Y}_{S} \\ {Z}_{S} \\ 1\end{matrix} ] = [ \begin{matrix}R & T \\ 0 & 1\end{matrix} ] [ \begin{matrix}{x}_{L} \\ {y}_{L} \\ {z}_{L} \\ 1\end{matrix} ]$ |
| Pixel coordinate system - spatial light distribution coordinate system | $[ \begin{matrix}{X}_{S} \\ {Y}_{S} \\ {Z}_{S} \\ 1\end{matrix} ] = [ \begin{matrix}R & T \\ 0 & 1\end{matrix} ] [ \begin{matrix}\frac{{z}_{L}}{f} & 0 & 0 \\ 0 & \frac{{z}_{L}}{f} & 0 \\ 0 & 0 & {z}_{L} \\ 0 & 0 & 1\end{matrix} ] [ \begin{matrix}dx & 0 & - {i}_{0} dx \\ 0 & dy & - {j}_{0} dy \\ 0 & 0 & 1\end{matrix} ] [ \begin{matrix}i \\ j \\ 1\end{matrix} ] = [ \begin{matrix}R & T \\ 0 & 1\end{matrix} ] [ \begin{matrix}\frac{{z}_{L} dx}{f} & 0 & \frac{- {z}_{L} {i}_{0} dx}{f} \\ 0 & \frac{{z}_{L} dy}{f} & \frac{- {z}_{L} {j}_{0} dy}{f} \\ 0 & 0 & {z}_{L} \\ 0 & 0 & 1\end{matrix} ] [ \begin{matrix}i \\ j \\ 1\end{matrix} ]$ |

As a technical solution, a standard light source with known spatial light distribution is placed at the sampling port to calibrate the imaging measurement unit. The spatial light distribution includes, but is not limited to, spatial luminance distribution, spatial luminous intensity distribution, spatial radiance luminance distribution, spatial radiant intensity distribution, or spatial chromaticity distribution, or a combination of two or three parameters among them.

This technical solution is characterized in that the standard light source is used to calibrate the imaging measurement unit, where light emitted by the standard light source irradiates the curved mesh screen, the imaging measurement unit aims to the curved mesh screen to obtain a light image formed by the diffuse transmission elements on the curved mesh screen, each light spot region corresponds to a spatial angle, and each point in the light image corresponds to a pixel of the area array sensor in the imaging measurement unit. The standard light source is used to calibrate the imaging measurement unit as follows: an incident angle and luminous intensity of rays irradiating each diffuse transmission element on the curved mesh screen are calculated according to the known spatial luminous intensity distribution (or luminance distribution) of the standard light source, and according to the established relationship between each pixel (i, j) or each pixel region centered on the pixel (i, j) in the imaging measurement unit and the spatial angle, that is, according to the position of the sampling port relative to the curved mesh screen (including distance and angle), and luminance distribution L(θ, φ) produced by the standard light source on the curved mesh screen is further calculated, where (θ, φ) represents position coordinates of each diffuse transmission element of the curved mesh screen, and the angle of the diffuse transmission element relative to the sampling port is (θ, φ); by comparing the response value R(i,j) of the pixel with the actual luminous intensity or luminance value of the standard light source at this spatial angle, a calibration coefficient k(i, j) for the pixel is calculated, that is, k(i,j)=R(i,j)/L(θ,φ).

The spot image of the light source illuminating the curved mesh screen is measured with the calibrated imaging measurement unit. The luminance viewing angle distribution of the light source is L′(θ,φ)=R′(i,j)/k(i,j), where R′(i,j) represents a response value of each pixel or pixel region of the light source on the imaging measurement unit. To make the measurement results more stable, edges of a light-emitting region can be determined according to the luminance distribution characteristics and edge features on the diffuse transmission elements of the curved mesh screen, and the influence of edge pixel response is eliminated during calculation to avoid crosstalk.

Similarly, if the spatial luminous intensity distribution of the light source is measured, a standard light source with known spatial luminous intensity distribution can be used for calibration, or the above standard light source with known luminance distribution can still be used for calibration, but the luminance value at each angle is multiplied by the projected area of the light-emitting surface (sampling port) at the corresponding angle.

It should be noted that the distance and angle between the imaging measurement unit and the curved mesh screen are fixed before and after calibration. This technical solution is relatively simple and easy to operate, and does not require complex debugging and debugging equipment. The calibration process eliminates possible systematic errors and inconsistencies between pixels in the imaging measurement unit, enabling the imaging measurement unit to be applicable to the measurement of light sources of different types and specifications, and improving the accuracy, universality and flexibility of the system.

As a further limitation of the above technical solution, the light-emitting angle of the standard light source covers a spatial angular range corresponding to all diffuse transmission elements on the curved mesh screen, that is, the light-emitting angle of the standard light source is greater than the angle between the line from the edge of the curved mesh screen to the center of the sampling port and the normal direction of the sampling port, or the standard light source rotates about the center of the sampling port to achieve calibration within a large angular range. This technical solution enables each diffuse transmission element on the curved mesh screen to be effectively calibrated by the imaging measurement unit, and therefore, is suitable for testing the luminous distribution of different light sources and can ensure the consistency and accuracy of measurement results.

As a further limitation of the above technical solution, the above standard light source has two or more different colors and two or more different intensities of light output, and the imaging measurement unit is calibrated with the standard light source under the light output of each color and intensity. Specifically, different colors include different color temperatures, such as 3000K, 4000K, 5000K, or 6500K, as well as different monochromatic lights, such as red light, blue light, green light, or yellow light. In actual measurement, it is only necessary to call the calibration data with the same or similar spectral distribution as the light source, or a spectral matrix can be established as needed for calibration. Through the response calibration of the imaging measurement unit and the curved mesh screen under the corresponding light output, not only can spectral mismatch errors of the imaging measurement unit be solved, but also linear errors existing in the imaging measurement unit can be reduced, ensuring the accuracy of measurement for the luminous distribution of the light source.

As a further limitation of the above technical solution, the output spectra and luminance of the above standard light source are adjustable, and the imaging measurement unit is calibrated one by one according to the above method under various output spectra and luminance. The calibration on luminance can further improve the linearity of the imaging measurement unit. The response calibration on various spectra can further improve the consistency of the imaging measurement unit in measuring different light sources, and can also be implemented by spectral matrices.

As another technical solution, the response of each pixel or pixel region in the imaging measurement unit is directly calibrated against a standard luminance source having a uniform light-emitting surface without passing through the curved mesh screen, or against a standard luminance source irradiating a standard white board without passing through the curved mesh screen; in spatial light distribution measurement, luminous distribution quantities of the light source are calculated based on the response of each pixel or pixel region, the spatial geometric relationship between the center of the sampling port and the diffuse transmission element, and the transmittance of the diffuse transmission elements. The imaging measurement unit is calibrated with the standard white board. Specifically, the imaging measurement unit is installed on a clamping device, where the photometric axis of the imaging measurement unit is in the same plane as that of an optical track at an angle of 45°; the imaging measurement unit aims to the center of the standard white board, the objective lens and ocular lens of the imaging measurement unit are adjusted to make the aperture diaphragm and the white board clearly visible, the current or voltage of the standard light source is increased to a specified value, and a standard luminance value is obtained through a formula

$$L = \frac{ρ}{π} \frac{1}{{r}^{2}} ,$$

where ρ represents a reflectivity of the standard white board, I represents a luminous intensity of the standard light source, and r represents a distance from the filament plane of the standard light source to the standard white board. From the calibrated imaging measurement unit, the luminous intensity distribution of the light source can be derived. Under the condition that the positions and attitudes of the curved mesh screen and the imaging measurement device are fixed, the illuminance measured by the given pixel corresponds to the luminous intensity of the light source in the specified direction. With the diffuse transmission element on the curved mesh screen as the connection, the luminous intensity of the light source in the specified direction is calculated through a formula

$$I ( i , j ) = \frac{k \cdot {M}_{p ixel} ( i , j ) \cdot {l}^{2} \cdot π \cdot {f}^{2}}{{cos}^{3} α ( i , j ) \cdot {τ}_{screen} \cdot {cos}^{3} β ( i , j ) \cdot {τ}_{lens}} ,$$

where (i, j) represents a pixel of the imaging measurement unit, and Mₚᵢₓₑₗ(i,j) represents a response value of the measured pixel (i,j) or the pixel region centered on the pixel(i,j); l represents a distance between the surface of the light source and each diffuse transmission element of the curved mesh screen; f represents a focal length of the lens in the imaging measurement unit; α(i, j) represents an angle formed by the normal direction of each diffuse transmission element and the l direction; β(i,j) represents an angle formed by the plane normal of the area detector in the imaging measurement unit and the line connecting the diffuse transmission element and the image plane (i,j); τ_{screen} represents the transmittance of the diffuse transmission element; τₗₑₙₛ represents the transmittance of the lens in the imaging measurement unit, and k represents a calibration coefficient. The constants and variables in the formula should be precisely measured or calculated.

As a technical solution, due to the limitation of the field of view of the imaging measurement unit, the field of view region of the imaging measurement unit may be less than or equal to the captured light spot region of the curved mesh screen. Therefore, the imaging measurement unit can be arranged on a rotating mechanism, the rotating mechanism drives the imaging measurement device to capture light images on the curved mesh screen from two or more different angles, and the light images are stitched into a complete light image; or two or more imaging measurement units are used to capture light images on the curved mesh screen from different angles respectively, and the images are stitched and cropped to obtain a complete light image, thereby obtaining luminous distribution quantities of the light source within a spatial range of interest, and solving the problem of inaccurate measurement due to the limitation of the field of view of the imaging measurement unit. At this point, the imaging measurement unit coordinate system is not parallel to the spatial light distribution coordinate system, requiring the imaging measurement unit coordinate system to translate and rotate about the x_{L}, y_{L}, z_{L} axis respectively based on certain parameters. When the imaging measurement unit is calibrated based on the geometric relationship, a calibration plate or object of known size is required to capture an image, and corresponding parameters are solved based on the relationship between the feature points of the image and the image coordinates. By establishing the relationship between each pixel (i,j) or each pixel region centered on the pixel (i,j) in the imaging measurement unit and the spatial angle, the entire curved mesh screen can be calibrate to precisely obtain angular resolved optical quantities of the light source. Preferably, severely distorted images are corrected, or images with high noise are de-noised, to solve a geometric transformation relationship between different light images; and in order to ensure visual consistency on each light image, the luminance of the images can be corrected. Alternatively, a special imaging measurement device with wide-angle or ultra-wide-angle lenses can be used to capture all light images at a single time.

The present invention further provides a device for measuring a luminous distribution, including a shielding device with a conical surface, a curved mesh screen, and an imaging measurement unit including an area array sensor, where the curved mesh screen is arranged at one end of the shielding device, and the surface of the curved mesh screen has diffuse transmission elements distributed in a grid pattern; and the shielding device is provided with a sampling port at the other end relative to the curved mesh screen, a to-be-measured region of a light source is placed at the sampling port, light emitted from the to-be-measured region irradiates the curved mesh screen to generate a light spot on each diffuse transmission element, the imaging measurement unit aims to the curved mesh screen to collect and measure a light image, and a data processing unit is used to calculate spatial luminous distribution quantities.

As a technical solution, the device further includes a standard light source for calibrating the imaging measurement unit, where the spatial light distribution of the standard light source is known. Based on the known spatial luminous intensity distribution data of the standard light source, the relationship between each pixel of the area array sensor and the luminous intensity or luminance value of the standard light source at different spatial angles is established. For each pixel, by comparing its response value with the actual luminous intensity or luminance value of the standard light source at that angle, the calibration coefficient of this pixel is calculated. The calibration coefficients of all pixels are stored for subsequent measurements. The calibrated imaging measurement unit is used to measure angle-related parameters such as luminous intensity, luminance, and chromaticity of the to-be-measured region of the light source, and the obtained measurement results are relatively accurate.

As a technical solution, two or more imaging measurement units comprising area array sensors are arranged at different angles and aim to the curved surface screen for capturing, respectively.

As a technical solution, the device further includes a sample stage, the light source is placed on the sample stage, and the to-be-measured region of the light source is adjusted by moving the sample stage. The to-be-measured region is automatically adjusted to meet different measurement requirements.

As a technical solution, in front of the optical path of the imaging measurement unit, further provided is a color filter that matches the spectral response function of the imaging measurement unit with the human eye's visual efficiency function V(λ), or color filters or band-pass color filters that match CIE (Commission Internationale de L'Eclairage) color matching functions x(λ), y(λ), and z(λ). Through a switching device, the color filters are switched to the optical path in sequence. For the viewing angle distribution of spectra, a plurality of band-pass filters can be used, covering a wavelength range of 380 nm to 780 nm. The imaging measurement unit acquires images under different filters and synthesizes the images to obtain spectra within the entire visible light band range.

The beneficial effects of the present invention are as follows: The present invention provides a method for measuring a luminous distribution, which achieves efficient and reliable measurement of luminance and chromaticity parameters at large viewing angles by means of diffuse transmission of the curved mesh screen and rapid measurement of the imaging measurement unit, has the advantages of rapid measurement, accurate measurement, high flexibility, low cost, etc., and is suitable for applications such as the research and development of projects related to light sources and quality control on production lines.

### BRIEF DESCRIPTION OF THE DRAWINGS

FIG. 1 is a schematic diagram of a device structure for a method for measuring a luminous distribution;

FIG. 2 is a schematic diagram of an overall measurement relationship between a light source and a curved mesh screen;

FIG. 3 is a schematic diagram of an image coordinate system and a pixel coordinate system;

FIG. 4 is a schematic diagram of a spatial coordinate system and an image coordinate system;

FIG. 5 is an image captured by an imaging measurement unit;

FIG. 6 is a distribution diagram of transmission elements of a curved mesh screen;

FIG. 7 is another distribution diagram of transmission elements of a curved mesh screen;

FIG. 8 is a schematic diagram of a geometric measurement structure for the method for measuring a luminous distribution;

FIG. 9 is a schematic diagram of a measurement structure of a plurality of imaging measurement units; and

FIG. 10 is a schematic diagram of stitching images captured by imaging measurement units at different positions.

Meanings of reference numerals are as follows: 1—light source, 11—to-be-measured region of the light source, 2—sample stage, 3—curved mesh screen, 31—diffuse transmission element, 32—sampling port, 4—shielding device, 5—imaging measurement unit, 51—lens, 52—color filter, 53—area array sensor, 54—captured image 1, 55—captured image 2, 56—captured image 3, and 57—complete light image.

### DETAILED DESCRIPTION OF THE EMBODIMENTS

To make the objectives, technical solutions, and advantages of the present invention clearer, the present invention is further described in detail below in conjunction with specific embodiments and the accompanying drawings.

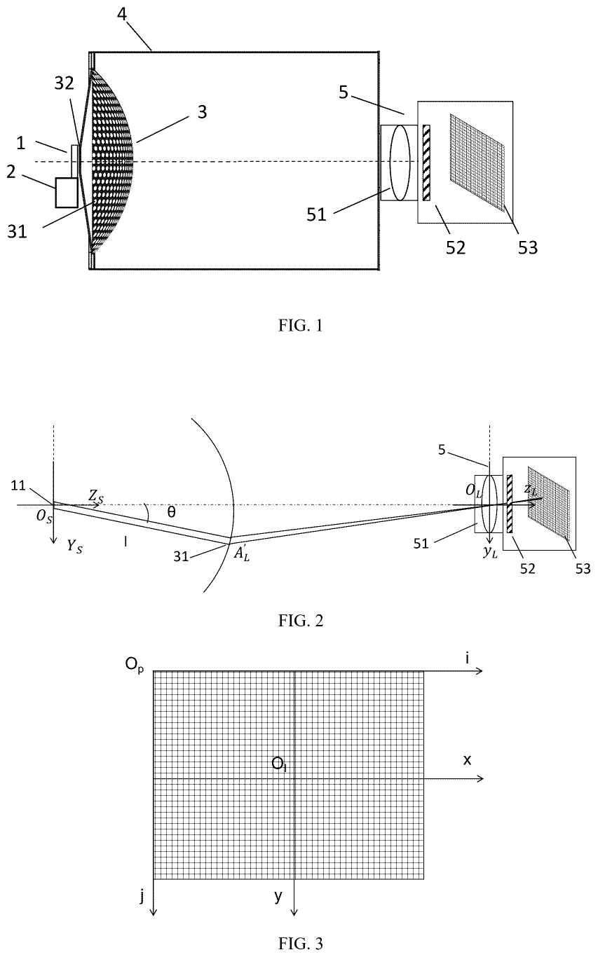

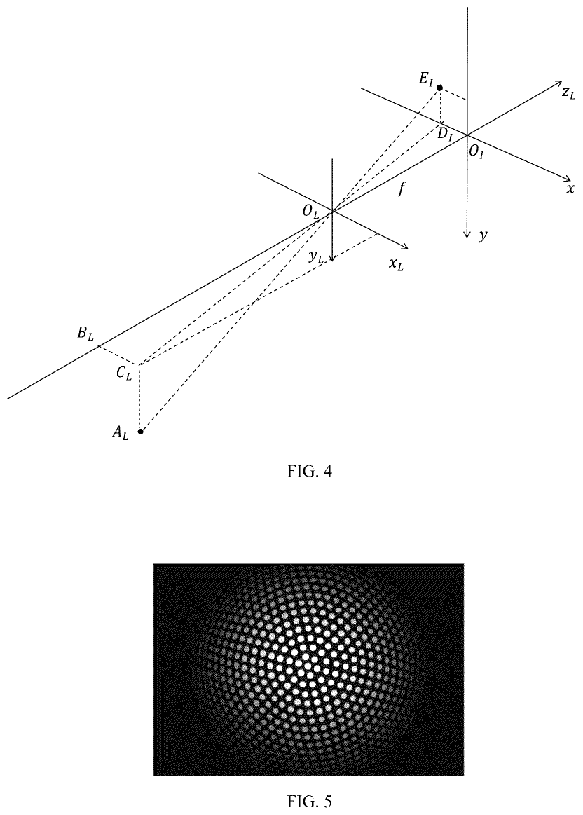

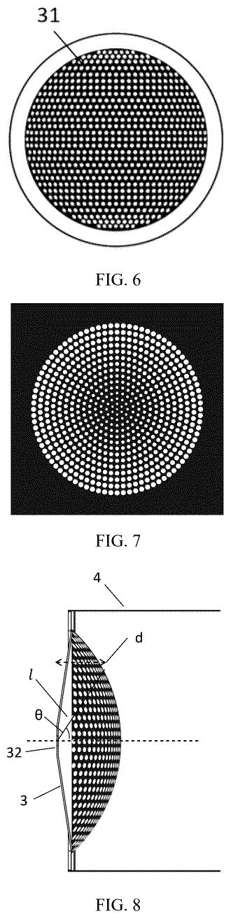

An embodiment discloses a device for measuring a luminous distribution, as shown in FIG. 1, including a shielding device 4 with a conical surface, a curved mesh screen 3, and an imaging measurement unit 5 including an area array sensor, where the curved mesh screen 3 is arranged at one end of the shielding device 4 coated with a black light-absorbing material on the inner wall, the surface of the curved mesh screen 3 has a plurality of diffuse transmission elements 31 distributed in a grid pattern, and the diffuse transmission elements 31 are distributed regularly; the shielding device 4 is provided with a sampling port 32 at the other end relative to the curved mesh screen, a light source 1 is placed on the sample stage 2, the sample stage 2 is a movable sample stage, a to-be-measured region 11 of the light source is placed at the sampling port 32 by moving the sample stage 2, light emitted from the to-be-measured region irradiates the curved mesh screen 3 to generate a light spot on each diffuse transmission element 31, and each light spot region corresponds to a specific spatial angle; the imaging measurement unit 5 aims to the curved mesh screen 3 to collect and measure a light image, and a data processing unit is used to calculate spatial luminous distribution quantities. The imaging measurement unit 5 includes a lens 51, a color filter 52, and an area array sensor 53, where the light passing through a diffuse transmission hole is received by the area array sensor 53 via the lens 51 and the color filter 52. In specific implementation, the shape and arrangement of the diffuse transmission elements can be reasonably designed based on a positional relationship between structural units. The size and quantity of the diffuse transmission elements also determine the precision of measuring the luminous distribution characteristics of the measured light source, and can be set according to actual measurement needs, as shown in FIGS. 5, 6, and 7.

An embodiment discloses a method for measuring a luminous distribution, which uses the curved mesh screen 3 and the imaging measurement unit 5 including the area array sensor to measure the spatial distribution of the light source 1, specifically, uses the imaging measurement unit 5 to obtain information of a light image formed by the diffuse transmission elements 31 on the curved mesh screen 3, and uses the data processing unit of the imaging measurement unit to analyze the angular resolved luminance value of the to-be-measured region. In this embodiment, the imaging measurement unit is first calibrated by a standard light source with known spatial luminance distribution, specifically including: the standard light source is placed at the sampling port, light emitted by the standard light source irradiates the curved mesh screen, the imaging measurement unit aims to the curved mesh screen to obtain a light image formed by the diffuse transmission elements on the curved mesh screen, each light spot region corresponds to a spatial angle, and each point in the light image corresponds to a pixel of the area array sensor in the imaging measurement unit. Based on the known spatial luminance distribution data of the standard light source, a relationship between each pixel or each pixel region of the area array sensor and a luminance value of the standard light source at a different spatial angle is established, and a calibration coefficient for each pixel is calculated by comparing its response value with the actual luminance value of the standard light source at that angle. It can be understood that the calibration coefficient k(i,j) for each pixel (i,j) in the imaging measurement unit is a ratio of the response value R(i,j) of the pixel to the luminance of the curved mesh screen at the position (x,y,z) corresponding to that pixel, namely, k(i, j)=R(i, j)/L(θ, φ). The light source is arranged at the sampling port, and the light image of the light source irradiating the curved mesh screen is measured to obtain a luminance viewing angle distribution L′(θ,φ)=R′(i,j)/k(i,j), where R′(i,j) represents a response value of each pixel on the imaging measurement unit. Since each display pixel of the imaging measurement unit requires several image sensor pixels to implement precise and stable pixel-level luminance measurement, the luminance viewing angle distribution L′(θ, φ) of the light source corresponds to an average value of different diffuse transmission element regions. In addition, the edge of a light-emitting region can be found based on the luminance distribution characteristics and edge features on the diffuse transmission elements of the curved mesh screen, and the influence of edge pixel responses is eliminated during calculation to avoid crosstalk.

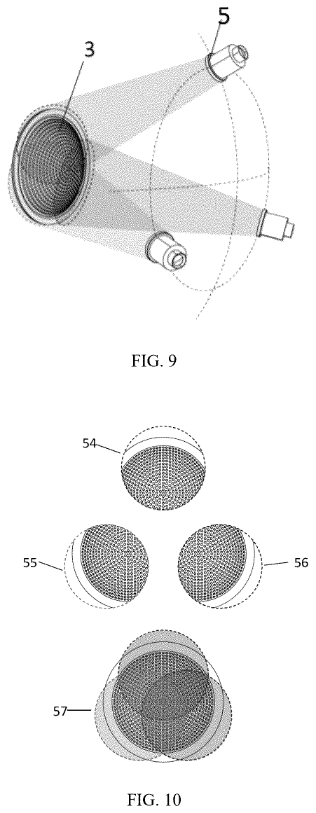

In another embodiment, as shown in FIG. 9 and FIG. 10, when the field of view of the imaging measurement unit used for measurement is relatively small, the field of view region of the imaging measurement unit cannot cover the light spot region of the curved mesh screen. Therefore, three imaging measurement units 5 having relatively small fields of view are used to capture light images 54, 55, and 56 on the curved mesh screen 3 from three different angles respectively, the images are stitched and cropped to obtain a complete light image 57, and then luminous distribution quantities (such as luminous intensity, luminance, chromaticity) of the to-be-measured region of the light source are obtained.

The above describes the specific embodiments of the present invention in conjunction with the accompanying drawings. However, those skilled in the art should understand that the above embodiments are only for illustration purposes and not to limit the scope of the present invention. Those skilled in the art should also understand that the above embodiments can be modified without departing from the scope and spirit of the present invention. The scope of protection of the present invention is defined by the appended claims.

1. A method for measuring a luminous distribution, wherein the spatial luminous distribution of a light source is measured through a curved mesh screen and an imaging measurement unit which comprises an area array sensor, a sampling port is involved, and the surface of the curved mesh screen has diffuse transmission elements distributed in a grid pattern; measuring steps comprise: placing a to-be-measured region of the light source at the sampling port, wherein light emitted from the to-be-measured region illuminates the curved mesh screen to form a light spot on each diffuse transmission element; obtaining a light image formed by the diffuse transmission elements on the curved mesh screen with the imaging measurement unit; and analyzing the light image by a data processing unit to obtain angular resolved optical quantities of the to-be-measured region.

2. The method for measuring the luminous distribution according to claim 1, wherein a standard light source with known spatial light distribution is placed at the sampling port to calibrate the imaging measurement unit, wherein the spatial light distribution comprises spatial luminance distribution, spatial luminous intensity distribution, spatial radiance distribution, spatial radiant intensity distribution, or spatial chromaticity distribution.

3. The method for measuring the luminous distribution according to claim 2, wherein the light-emitting angle of the standard light source is greater than the angle between the line from the edge of the curved mesh screen to the center of the sampling port and the normal direction of the sampling port, or the standard light source rotates about the center of the sampling port to achieve calibration within a large angular range.

4. The method for measuring the luminous distribution according to claim 1, wherein a relationship between each pixel or pixel region of the area array sensor in the imaging measurement unit and a spatial light-emitting angle from the to-be-measured region is established based on the spatial position relationship between each diffuse transmission element on the curved mesh screen and the sampling port, and the position relationship between the diffuse transmission element and the imaging measurement unit.

5. The method for measuring the luminous distribution according to claim 4, wherein a spatial angular coordinate system for the diffuse transmission elements is established with the center of the sampling port as its origin; each diffuse transmission element corresponds to one pixel or pixel region in the imaging measurement unit, and their corresponding geometric relationship is calibrated; and a relationship between pixel coordinates in the imaging measurement unit and spatial angular coordinates is established.

6. The method for measuring the luminous distribution according to claim 1, wherein the response of each pixel or pixel region in the imaging measurement unit is directly calibrated against a standard luminance source having a uniform light-emitting surface without passing through the curved mesh screen; in spatial light distribution measurement, luminous distribution quantities of the light source are calculated based on the response of each pixel or pixel region, the spatial geometric relationship between the center of the sampling port and the diffuse transmission element, and the transmittance of the diffuse transmission elements.

7. The method for measuring the luminous distribution according to claim 1, wherein the imaging measurement unit is arranged on a rotating mechanism, and the rotating mechanism drives the imaging measurement device to capture light images on the curved mesh screen from two or more different angles; or two or more imaging measurement units are used to capture light images on the curved mesh screen from different angles respectively, and the images are stitched and cropped to obtain luminous distribution quantities of the light source within a spatial range of interest.

8. A measuring device based on the method for measuring a luminous distribution according to claim 1, comprising a shielding device with a conical surface, a curved mesh screen, and an imaging measurement unit comprising an area array sensor, wherein the curved mesh screen is arranged at one end of the shielding device, and the surface of the curved mesh screen has diffuse transmission elements distributed in a grid pattern; and the shielding device is provided with a sampling port at the other end relative to the curved mesh screen, a to-be-measured region of a light source is placed at the sampling port, light emitted from the to-be-measured region irradiates the curved mesh screen to generate a light spot on each diffuse transmission element, the imaging measurement unit aims to the curved mesh screen to collect and measure a light image, and a data processing unit is used to calculate spatial luminous distribution quantities.

9. The measuring device according to claim 8, further comprising a standard light source with known spatial light distribution information for calibrating the imaging measurement unit.

10. The measuring device according to claim 8, further comprising a sample stage, wherein the light source is placed on the sample stage, and the to-be-measured region of the light source is adjusted by moving the sample stage.

11. The method for measuring the luminous distribution according to claim 2, wherein a relationship between each pixel or pixel region of the area array sensor in the imaging measurement unit and a spatial light-emitting angle from the to-be-measured region is established based on the spatial position relationship between each diffuse transmission element on the curved mesh screen and the sampling port, and the position relationship between the diffuse transmission element and the imaging measurement unit.

12. The method for measuring the luminous distribution according to claim 11, wherein a spatial angular coordinate system for the diffuse transmission elements is established with the center of the sampling port as its origin; each diffuse transmission element corresponds to one pixel or pixel region in the imaging measurement unit, and their corresponding geometric relationship is calibrated; and a relationship between pixel coordinates in the imaging measurement unit and spatial angular coordinates is established.

13. The method for measuring the luminous distribution according to claim 2, wherein the imaging measurement unit is arranged on a rotating mechanism, and the rotating mechanism drives the imaging measurement device to capture light images on the curved mesh screen from two or more different angles; or two or more imaging measurement units are used to capture light images on the curved mesh screen from different angles respectively, and the images are stitched and cropped to obtain luminous distribution quantities of the light source within a spatial range of interest.

14. The method for measuring the luminous distribution according to claim 3, wherein the imaging measurement unit is arranged on a rotating mechanism, and the rotating mechanism drives the imaging measurement device to capture light images on the curved mesh screen from two or more different angles: or two or more imaging measurement units are used to capture light images on the curved mesh screen from different angles respectively, and the images are stitched and cropped to obtain luminous distribution quantities of the light source within a spatial range of interest.

15. The method for measuring the luminous distribution according to claim 4, wherein the imaging measurement unit is arranged on a rotating mechanism, and the rotating mechanism drives the imaging measurement device to capture light images on the curved mesh screen from two or more different angles; or two or more imaging measurement units are used to capture light images on the curved mesh screen from different angles respectively, and the images are stitched and cropped to obtain luminous distribution quantities of the light source within a spatial range of interest.

16. The method for measuring the luminous distribution according to claim 11, wherein the imaging measurement unit is arranged on a rotating mechanism, and the rotating mechanism drives the imaging measurement device to capture light images on the curved mesh screen from two or more different angles; or two or more imaging measurement units are used to capture light images on the curved mesh screen from different angles respectively, and the images are stitched and cropped to obtain luminous distribution quantities of the light source within a spatial range of interest.

17. The method for measuring the luminous distribution according to claim 5, wherein the imaging measurement unit is arranged on a rotating mechanism, and the rotating mechanism drives the imaging measurement device to capture light images on the curved mesh screen from two or more different angles; or two or more imaging measurement units are used to capture light images on the curved mesh screen from different angles respectively, and the images are stitched and cropped to obtain luminous distribution quantities of the light source within a spatial range of interest.

18. The method for measuring the luminous distribution according to claim 12, wherein the imaging measurement unit is arranged on a rotating mechanism, and the rotating mechanism drives the imaging measurement device to capture light images on the curved mesh screen from two or more different angles: or two or more imaging measurement units are used to capture light images on the curved mesh screen from different angles respectively, and the images are stitched and cropped to obtain luminous distribution quantities of the light source within a spatial range of interest.

19. The method for measuring the luminous distribution according to claim 6, wherein the imaging measurement unit is arranged on a rotating mechanism, and the rotating mechanism drives the imaging measurement device to capture light images on the curved mesh screen from two or more different angles; or two or more imaging measurement units are used to capture light images on the curved mesh screen from different angles respectively, and the images are stitched and cropped to obtain luminous distribution quantities of the light source within a spatial range of interest.
